(19) United States
(12) Patent Application Publication
(10) Pub. No.: US 2018/0226687 A1
(43) Pub. Date: Aug. 9, 2018

(54) ELECTRODE ASSEMBLY OF LITHIUM ION SECONDARY BATTERY AND METHOD FOR PRODUCING SAME

(71) Applicant: KABUSHIKI KAISHA TOYOTA JIDOSHOKKI, Kariya-shi, Aichi (JP)

(72) Inventors: Shinya ASAI, Kariya-shi (JP); Atsushi MINAGATA, Kariya-shi (JP); Hiroyasu NISHIHARA, Kariya-shi (JP); Yasuyuki GODA, Kariya-shi (JP)

(73) Assignee: KABUSHIKI KAISHA TOYOTA JIDOSHOKKI, Kariya-shi, Aichi (JP)

(21) Appl. No.: 15/746,264

(22) PCT Filed: Jul. 20, 2016
(86) PCT No.: PCT/JP2016/071267

§ 371 Date: Jan. 19, 2018

(30) Foreign Application Priority Data
Jul. 22, 2015 (JP) 2015-145088

(51) Int. Cl. H01M 10/0585; H01M 10/0525; H01M 2/18

(52) U.S. Cl. CPC H01M 10/0585; H01M 2/18; H01M 10/0525

(57) ABSTRACT

An electrode assembly is an electrode assembly of a lithium ion secondary battery in which sheet-like positive electrodes and sheet-like negative electrodes are alternately stacked, with bag-like separators interposed therebetween. The area of the first main surface of each of the positive electrodes is smaller than the area of the first main surface of each of the negative electrodes, and the area of the second main surface of each of the positive electrodes is smaller than the area of the second main surface of each of the negative electrodes. The first main surfaces of the positive electrodes and the negative electrodes are opposed to each other, with the respective bag-like separators interposed therebetween, and the second main surfaces of the positive electrodes and the negative electrodes are opposed to each other, with the respective bag-like separators interposed therebetween.

### TECHNICAL FIELD

An aspect of the present invention relates to an electrode assembly of a lithium ion secondary battery, and a method for producing the same.

### BACKGROUND ART

As an conventional electrode assembly of a secondary battery, an electrode assembly having a structure in which positive electrodes and negative electrodes are alternately stacked with separators interposed therebetween has been known. A known method for producing the electrode assembly is one that includes a step of applying and drying electrode slurry onto both surfaces of a metal foil to make a band-like electrode material in which active material layers are formed, a step of cutting single-piece electrodes out of the band-like electrode material, and a step of stacking the electrodes, and fixing the electrodes after stacking to form an electrode assembly. A producing method disclosed in Patent Literature 1 is known as an example of the step of cutting electrodes. In the producing method, laser beam is applied to a band-like electrode material in which active material layers are intermittently formed, to cut out electrodes from the band-like electrode material. Patent Literature 2 discloses a method of continuously cutting electrodes out of a band-like electrode material with a rotary cutter. Patent Literature 3 discloses a method of cutting electrodes out of a band-like electrode material, with a punching blade moving forward and backward in a vertical direction.

### CITATION LIST

### Patent Literature

Patent Literature 1: Japanese Unexamined Patent Publication No. 2012-221912

Patent Literature 2: Japanese Unexamined Patent Publication No. H9-312156

Patent Literature 3: Japanese Unexamined Patent Publication No. 2011-204613

### SUMMARY OF INVENTION

### Technical Problem

As disclosed in Patent Literature 2, a method of continuously cutting single-piece electrodes out of a band-like electrode material generates no waste mill ends between electrodes, and is excellent in respect of cost and material saving. However, such a producing method has the following problem, when it is applied to production of electrodes for a lithium ion secondary battery. Specifically, as illustrated in FIG. 13, a lithium ion secondary battery requires a design in which main surfaces 112a (external surfaces of negative electrode active material layers) of negative electrodes 112 are designed to have areas larger than those of main surfaces 111a (external surfaces of positive electrode active material layers) of positive electrodes 111 opposed to thereto, to cover the main surfaces 111a of the positive electrodes 111 with the main surfaces 112a of the negative electrodes 112, to suppress publicly known defect of lithium deposition. By contrast, because the capacity of the lithium ion secondary battery decreases as the area of the main surfaces 111a of the positive electrodes 111 reduces, a lithium ion secondary battery requires designing the main surfaces of the positive electrodes 111 as large as possible, also in consideration of the manufacturing error, while the aforementioned condition is satisfied. As described above, a lithium ion secondary battery requires securing the capacity of the lithium ion secondary battery, while lithium deposition is suppressed.

In particular, when single-piece electrodes are continuously cut out to prevent generation of end mills as disclosed in Patent Literature 2, the end surface of the cut portion may be inclined, and areas of two main surfaces (front and back surfaces) of the electrode may be different from each other. The rotary cutter requires setting the blade edge angle to, for example, 50° or more, to provide the cutter with durability enough to continuously cut a hard active material layer, and has difficulty in reducing the inclination of the end surface of the electrode. For this reason, in the case of using a rotary cutter as described above, a design is required to further reduce the main surfaces 111a of the positive electrodes 111 in consideration of the inclination of the end surfaces of the negative electrodes 112, as illustrated in FIG. 14. Such a design causes more difficulty in securing the capacity of the lithium ion secondary battery.

In the same manner, the areas of the two main surfaces of the each of the electrodes may be different from each other, also in the case of using laser beam when electrodes are cut out of the band-like electrode material. When single-piece electrodes are cut out with laser beam, for example, the laser beam is focused on a metal foil that is most difficult to cut. In this manner, the part around the focus is molten with heat of the laser beam. However, because the temperature of the laser beam application side in front of the focus becomes higher than that of the opposite side of the focus, the molten quantity of the laser beam application side is larger than the molten quantity of the opposite side of the focus. For this reason, in the two main surfaces of each of the electrodes, the area of the main surface on the laser beam application side becomes smaller than the area of the other main surface. As described above, also in the case of using laser beam, a design is required to further reduce the main surfaces of the positive electrodes in consideration of the molten quantity of the end surfaces of the negative electrodes, and more difficulty exists in securing the capacity of the lithium ion secondary battery.

An object of an aspect of the present invention is to provide an electrode assembly of a lithium ion secondary battery, and a method for producing the same that secure the capacity, while lithium deposition is suppressed.

### Solution to Problem

An electrode assembly of a lithium ion secondary battery according to an aspect of the present invention is an electrode assembly of a lithium ion secondary battery in which sheet-like positive electrodes and sheet-like negative electrodes are alternately stacked, with separators interposed therebetween, in which the positive electrodes each include an positive electrode collector and a pair of positive electrode active material layers formed on front and back surfaces of the positive electrode collector, the negative electrodes each include a negative electrode collector and a pair of negative electrode active material layers formed on front and back surfaces of the negative electrode collector, external surfaces of the positive electrode active material layers form a first main surface of the positive electrode and a second main surface of the positive electrode with an area smaller than an area of the first main surface, external surfaces of the negative electrode active material layers form a first main surface of the negative electrode and a second main surface of the negative electrode with an area smaller than an area of the first main surface, the area of the first main surface of each of the positive electrodes is smaller than the area of the first main surface of each of the negative electrodes, the area of the second main surface of each of the positive electrodes is smaller than the area of the second main surface of each of the negative electrodes, the first main surfaces of the positive electrodes and the negative electrodes are opposed to each other, with the respective separators interposed therebetween, and the second main surfaces of the positive electrodes and the negative electrodes are opposed to each other, with the respective separators interposed therebetween.

In the electrode assembly, the first main surfaces of the positive electrodes and the negative electrodes are opposed to each other, with the respective separators interposed therebetween, and the second main surfaces of the positive electrodes and the negative electrodes are opposed to each other, with the respective separators interposed therebetween. With this structure, the degree of consideration of the difference in area between the first main surface and the second main surface of each of the negative electrodes can be reduced in design of the positive electrodes, and the sizes of the first main surfaces and the second main surfaces of the positive electrodes can be increased as compared with those in conventional electrode assemblies.

Accordingly, this structure secures the capacity of the lithium ion secondary battery, while lithium deposition is suppressed.

In an embodiment, the positive electrodes may be contained in respective bag-like separators, each of which being formed by welding peripheral edge portions of two sheet-like separators, and the welded portions of the bag-like separators may be positioned on the first main surface side of the positive electrodes. In this case, the welded portions of the separators are superposed on the lower ends of the negative electrodes grounded in the case, and thus load concentration on the lower ends of the negative electrodes in grounding can be suppressed.

In an embodiment, molten portions may be formed on the respective end surfaces of each of the positive electrodes and the negative electrodes, and each of the molten portions may include a main molten portion positioned on the second main surface side, and a subsidiary molten portion positioned on the first main surface side and having a molten quantity smaller than a molten quantity of the main molten portion. In this case, this structure enables easy cutting of electrodes, by applying laser beam from the first main surface side, for example.

In an embodiment, the positive electrodes may be contained in respective bag-like separators, each of which being formed by welding peripheral edge portions of two sheet-like separators, and the welded portions of the bag-like separators may extend toward edge portions of the welded portions so as to be away from the first main surfaces of the positive electrodes. In the electrode assembly in which external surfaces of a pair of negative electrode active material layers are formed of the first main surface and the second main surface having an area smaller than that of the first main surface, the negative electrode active material particles more easily fall off the edge portions of the first main surfaces than those on the edge portions of the second main surfaces of the negative electrodes do, and easily form a large aggregate of particles. With the structure, because a relatively large space S is formed between the first main surface of each of the negative electrodes and the welded portion of the bag-like separator, the negative electrode active material falling off the edge portion of the first main surface of the negative electrode is easily contained in the space. Consequently, this structure prevents the fallen negative electrode active material from entering a space between the main surfaces of the positive electrode and the negative electrode.

In an embodiment, end surfaces of the positive electrodes and the negative electrodes may be inclined with respect to the first main surfaces and the second main surfaces. In this case, electrodes can be easily cut out using, for example, a cutting blade.

A method for producing an electrode assembly of a lithium ion secondary battery according to an aspect of the present invention is a method for producing an electrode assembly of a lithium ion secondary battery, comprising: a positive electrode forming step of continuously applying positive electrode active material to front and back surfaces of a band-like positive electrode collector to form a band-like positive electrode member; a negative electrode forming step of continuously applying negative electrode active material to front and back surfaces of a band-like negative electrode collector to form a band-like negative electrode member; an positive electrode cutting step of continuously cutting positive electrodes, each having a first main surface and a second main surface having an area smaller than an area of the first main surface, out of the band-like positive electrode member; a negative electrode cutting step of continuously cutting negative electrodes, each having a first main surface and a second main surface having an area smaller than an area of the first main surface, out of the band-like negative electrode member; and a stacking step of alternately stacking the positive electrodes and the negative electrodes, with respective separators interposed therebetween such that the first main surfaces of the cut positive electrodes and the cut negative electrodes are opposed to each other, with the respective separators interposed therebetween, and the second main surfaces of the cut positive electrodes and the cut negative electrodes are opposed to each other, with the respective separators interposed therebetween.

In the method, in the stacking step, the first main surfaces of the cut positive electrodes and the cut negative electrodes are opposed to each other, with the respective separators interposed therebetween, and the second main surfaces of the cut positive electrodes and the cut negative electrodes are opposed to each other, with the respective separators interposed therebetween. By this method, the degree of consideration of the difference in area between the first main surface and the second main surface of each of the negative electrodes can be reduced in design of the positive electrodes, and the sizes of the first main surface and the second main surface of each of the positive electrodes can be increased as compared with those by conventional methods. Accordingly, this method secures the capacity of the lithium ion secondary battery, while lithium deposition is suppressed. Besides, because the positive electrodes are continuously cut out of the band-like positive electrode member, and the negative electrodes are continuously cut out of the band-like negative electrode member, no end mills are generated, and thus the material can be saved.

In an embodiment, in the positive electrode cutting step and the negative electrode cutting step, the band-like positive electrode member and the band-like negative electrode member may be conveyed in the horizontal direction, and the conveyed band-like positive electrode member and the conveyed band-like negative electrode member may be cut from above with a processing tool, and in the stacking step, either the cut positive electrodes or the cut negative electrodes may be inverted vertically, and thereafter the positive electrodes and the negative electrodes may be alternately stacked, with the separators interposed therebetween. This method enables the processing tool to be disposed on the upper side of the conveying path, and improves maintainability. In addition, vertically inverting one of the electrodes before stacking causes the first main surfaces having large areas in the positive electrodes and the negative electrodes to be opposed to each other.

### Advantageous Effects of Invention

An aspect of the present invention secures the capacity of the lithium ion secondary battery, while lithium deposition is suppressed.

### BRIEF DESCRIPTION OF DRAWINGS

FIG. 1 is a cross-sectional view illustrating an internal structure of a lithium ion secondary battery provided with an electrode assembly according to a first embodiment;

FIG. 2 is a cross-sectional view taken along line II-II of FIG. 1;

FIG. 3 is an enlarged cross-sectional view illustrating part of the electrode assembly of FIG. 1;

FIG. 4 is a diagram illustrating a negative electrode formation step of applying a negative electrode active material to both surfaces of a band-like metal foil to form a band-like negative electrode member;

FIG. 5 is a diagram illustrating a negative electrode cutting step of applying laser beam to the band-like negative electrode member to cut out negative electrodes;

FIG. 6 is a diagram illustrating a stacking step of stacking positive electrodes and negative electrodes;

FIG. 7 is an enlarged cross-sectional view illustrating part of an electrode assembly according to a second embodiment;

FIG. 8 (a) is a diagram illustrating a negative electrode cutting step of cutting the band-like negative electrode member with a cutting blade, to cut out negative electrodes, and FIG. 8 (b) is a diagram illustrating an positive electrode cutting step of cutting a band-like positive electrode member with a cutting blade, to cut out positive electrodes;

FIG. 9 is an enlarged view of the positive electrode cutting step of FIG. 8 (a);

FIG. 10 is an enlarged cross-sectional view illustrating part of an electrode assembly according to Modification 1;

FIG. 11 is an enlarged cross-sectional view illustrating part of an electrode assembly according to Modification 2;

FIG. 12 is an enlarged cross-sectional view illustrating part of a modification of the electrode assembly of FIG. 1;

FIG. 13 is an enlarged cross-sectional view illustrating part of a conventional example of an electrode assembly of a lithium ion secondary battery; and

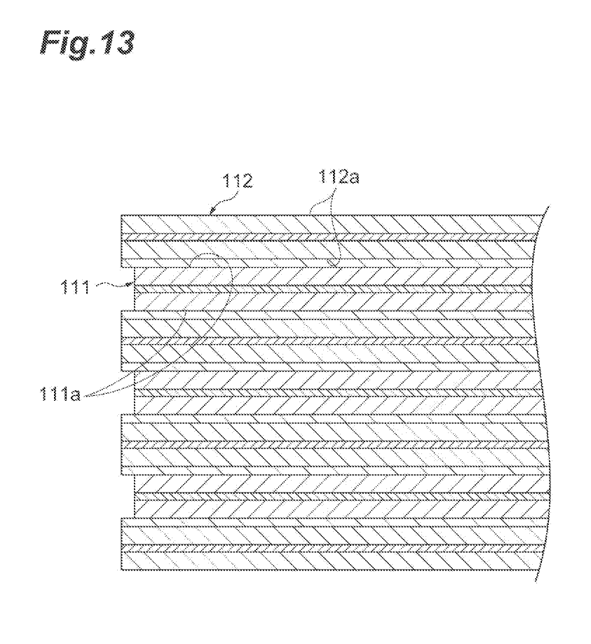

FIG. 14 is an enlarged cross-sectional view illustrating part of another conventional example of an electrode assembly of a lithium ion secondary battery.

### DESCRIPTION OF EMBODIMENTS

The following is detailed explanation of an embodiment with reference to drawings. In the drawings, the same elements are denoted with the same reference numerals, and overlapping explanation is omitted.

### First Embodiment

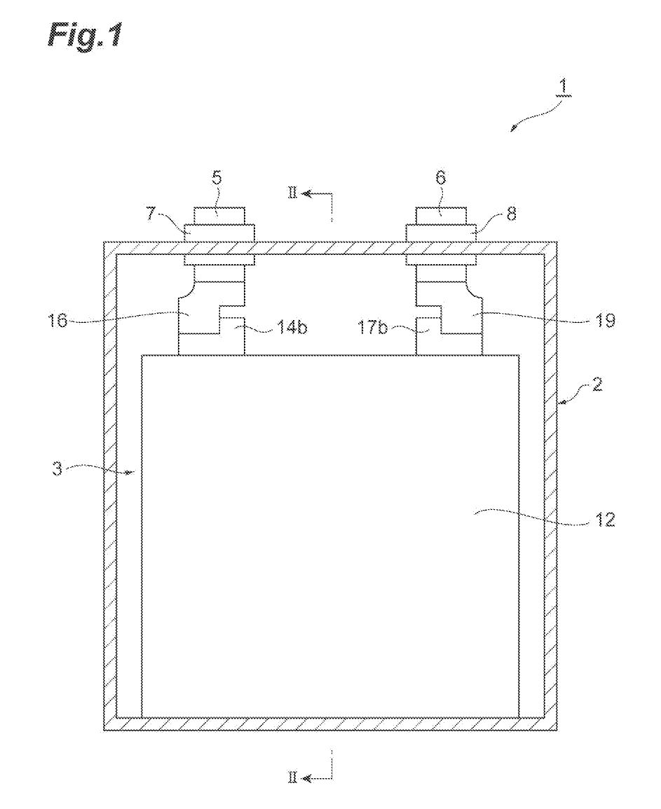

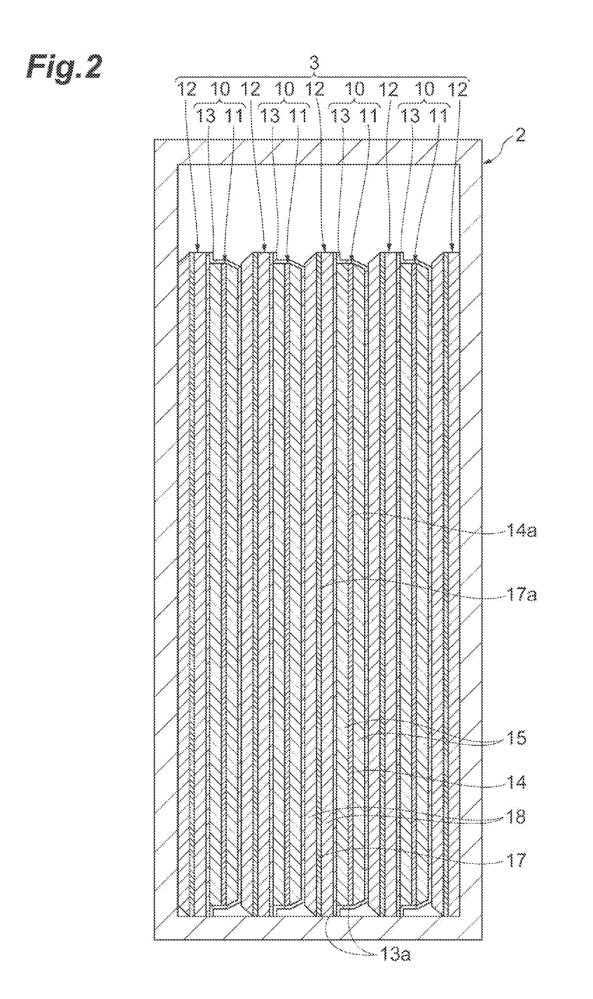

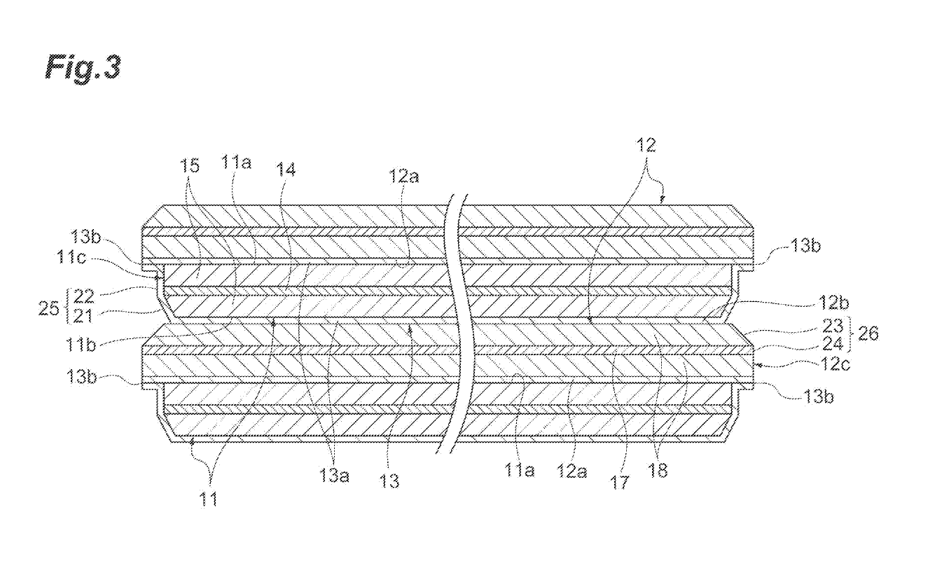

FIG. 1 is a cross-sectional view illustrating an internal structure of a lithium ion secondary battery provided with an electrode assembly according to a first embodiment. FIG. 2 is a cross-sectional view taken along line II-II in FIG. 1. FIG. 3 is an enlarged view of part of the electrode assembly of FIG. 1. A lithium ion secondary battery 1 is configured as, for example, an in-vehicle nonaqueous electrolyte secondary battery.

As illustrated in FIG. 1, the lithium ion secondary battery 1 includes a hollow case 2 having, for example, a substantially rectangular parallelepiped shape, and an electrode assembly 3 contained in the case 2. The case 2 is formed of metal such as aluminum. An insulating film (not illustrated) is provided on an internal wall surface of the case 2. For example, a nonaqueous organic solvent-based electrolyte is injected into the inside of the case 2. In the electrode assembly 3, positive electrode active material layers (positive electrode active material) 15 of positive electrodes 11, negative electrode active material layers (negative electrode active material) 18 of negative electrodes 12, and bag-like separators (separators) 13 are porous, and the electrolyte is impregnated into pores thereof. A positive electrode terminal 5 and a negative electrode terminal 6 are arranged apart from each other on an upper surface of the case 2. The positive electrode terminal 5 is fixed to the case 2 with an insulating ring 7 interposed therebetween, and the negative electrode terminal 6 is fixed to the case 2 with an insulating ring 8 interposed therebetween.

As illustrated in FIG. 2, the electrode assembly 3 is formed of positive electrodes 11 and negative electrodes 12, and bag-like separators 13 disposed between the positive electrodes 11 and the negative electrodes 12. The positive electrodes 11 are contained in the bag-like separators 13. In the state where the positive electrodes 11 are contained in the bag-like separators 13, the positive electrodes 11 and the negative electrodes 12 are alternately stacked with the bag-like separators 13 interposed therebetween. Specifically, the electrode assembly 3 includes separator-wearing positive electrodes 10 formed by containing the positive electrodes 11 in the bag-like separators 13.

Each of the positive electrodes 11 includes, for example, a metal foil (positive electrode collector) 14 formed of, for example, an aluminum foil, and a pair of positive electrode active material layers 15 formed on front and back surfaces of the metal foil 14. The metal foil 14 is formed of a metal foil main member portion 14a having a substantially rectangular shape, and a tab 14b (see FIG. 1) formed on an upper edge portion of the metal foil main member portion 14a to correspond to the position of the positive electrode terminal 5. The tab 14b extends upward from the upper edge portion of the metal foil main member portion 14a, and is connected with the positive electrode terminal 5 through a conductive member 16.

External surfaces of the positive electrode active material layers 15 forming a pair form a first main surface 11a of the positive electrode 11 and a second main surface 11b of the positive electrode 11 having an area smaller than that of the first main surface 11a. A surface of the tab 14b on which no positive electrode active material layer 15 is formed is not included in the first main surface 11a and the second main surface 11b of the positive electrode 11. The positive electrode active material layer 15 is a porous layer including the positive electrode active material and a binder. In other words, the positive electrode active material is supported on both surfaces of the metal foil main member portions 14a. Examples of the positive electrode active material include, a complex oxide, metal lithium, and sulfur. The complex oxide includes, for example, at least one of manganese, nickel, cobalt, and aluminum, and lithium. The term “main surface” herein is a main plane surface occupying most of the external surface of the active material layer. The first main surface 11a and the second main surface 11b, which are the main surfaces of the positive electrode, are opposed, respectively, to the first main surface 12a and the second main surface 12b, which are the main surfaces of the negative electrode, via the packet-like separator 13, and lithium ions move between each of the opposing main surfaces of the positive and negative electrodes.

Each of the negative electrodes 12 includes a metal foil (negative electrode collector) 17 formed of, for example, a copper foil, and a pair of negative electrode active material layers 18 formed on front and back surfaces of the metal foil 17. The metal foil 17 is formed of a metal foil main member portion 17a having a substantially rectangular shape, and a tab 17b formed on an upper edge portion of the metal foil main member portion 17a to correspond to the position of the negative electrode terminal 6. The tab 17b extends upward from the upper edge portion of the metal foil main member portion 17a, and is connected with the negative electrode terminal 6 through a conductive member 19.

External surfaces of the negative electrode active material layers 18 forming a pair form a first main surface 12a of the negative electrode 12 and a second main surface 12b of the negative electrode 12 having an area smaller than that of the first main surface 12a. The negative electrode active material layer 18 is a porous layer including the positive electrode active material and a binder. In other words, the negative electrode active material is supported on both surfaces of the metal foil main member portions 17a. Examples of the negative electrode active material include, carbon such as graphite, highly oriented graphite, meso-carbon microbeads, hard carbon, and soft carbon, alkaline metal such as lithium and sodium, a metal compound, a metal oxide such as SiOx (0.5≤x≤1.5), and boron-doped carbon.

Each of the bag-like separators 13 is formed in a sac shape, for example, and contains only the positive electrode 11 inside. Each of the bag-like separators 13 is formed by welding peripheral portions of two sheet-like separators 13a. Welded portions 13b of each of the bag-like separator 13 are positioned on the first main surface 12a side of the positive electrode 11. Examples of the material forming the bag-like separators 13 include a porous film formed of polyolefin-based resin such as polyethylene (PE) and polypropylene (PP), and woven cloth or nonwoven cloth formed of polypropylene, polyethylene terephthalate (PET), and methyl cellulose. The tabs 14b and 17b of the positive electrodes 11 and the negative electrodes 12 project upward from the substantially rectangular bag-like separators 13 (they are not illustrated in FIG. 2).

The following is detailed explanation of the structures of the positive electrodes 11 and the negative electrodes 12, with reference to FIG. 3.

As illustrated in FIG. 3, each of the positive electrodes 11 includes two main surfaces formed of a first main surface 11a and a second main surface 11b opposed to each other and having different areas, and an end surface 11c positioned to surround the first main surface 11a and the second main surface 11b, and connected with the first main surface 11a and the second main surface 11b. One of the first main surface 11a and the second main surface 11b serves as a front surface of the positive electrode 11, and the other of the first main surface 11a and the second main surface 11b serves as a back surface of the positive electrode 11. The area of the first main surface 11a is larger than the area of the second main surface 11b.

The end surface 11c is provided with a tapered molten portion 25 formed by application of laser beam. The molten portion 25 includes a main molten portion 21 positioned on the second main surface 11b side, and a subsidiary molten portion 22 positioned on the first main surface 11a side. The subsidiary molten portion 22 rises substantially vertically from one side of the first main surface 11a. The main molten portion 21 is inclined inward from one end of the subsidiary molten portion 22, and reaches the second main surface 11b. Specifically, the inclination angle of the main molten portion 21 is larger than the inclination angle of the subsidiary molten portion 22. The molten portion 25 is formed due to sag caused by influence of heat generated by application of laser beam. In the positive electrode 11, the molten quantity of the main molten portion 21 is larger than the molten quantity of the subsidiary molten portion 22.

Each of the negative electrodes 12 includes two main surfaces formed of a first main surface 12a and a second main surface 12b opposed to each other and having different areas, and an end surface 12c positioned to surround the first main surface 12a and the second main surface 12b, and connected with the first main surface 12a and the second main surface 12b. One of the first main surface 12a and the second main surface 12b serves as a front surface of the negative electrode 12, and the other of the first main surface 12a and the second main surface 12b serves as a back surface of the negative electrode 12. The area of the first main surface 12a is larger than the area of the second main surface 12b. In addition, the area of the first main surface 12a of the negative electrode 12 is larger than the area of the first main surface 11a of the positive electrode 11, and the area of the second main surface 12b of the negative electrode 12 is larger than the area of the second main surface 11b of the positive electrode 11.

The end surface 12c is provided with a tapered molten portion 26 formed by application of laser beam. The molten portion 26 includes a main molten portion 23 positioned on the second main surface 12b side, and a subsidiary molten portion 24 positioned on the first main surface 12a side. The subsidiary molten portion 24 rises substantially vertically from one side of the first main surface 12a. The main molten portion 23 is inclined inward from one end of the subsidiary molten portion 24, and reaches the second main surface 12b. Specifically, the inclination angle of the main molten portion 23 is larger than the inclination angle of the subsidiary molten portion 24. The molten portion 26 is formed due to sag caused by influence of heat generated by application of laser beam. In the negative electrode 12, the molten quantity of the main molten portion 23 is larger than the molten quantity of the subsidiary molten portion 24.

The following is explanation of the stacked state of the positive electrodes 11 and the negative electrodes 12. The first main surfaces 11a and 12a of the positive electrodes 11 and the negative electrodes 12 are opposed to each other with the respective bag-like separators 13 interposed therebetween. The second main surfaces 11b and 12b of the positive electrodes 11 and the negative electrodes 12 are opposed to each other with the respective bag-like separators 13 interposed therebetween.

The following is explanation of a method for producing the electrode assembly 3. The method for producing the electrode assembly 3 includes a step of producing positive electrodes 11, a step of producing negative electrodes 12, a step of producing separator-wearing positive electrodes 10, a step of inverting the separator-wearing positive electrodes 10, and a stacking step of stacking the separator-wearing positive electrodes 10 and the negative electrodes 12. The order of the steps is the step of producing positive electrodes 11, the step of producing negative electrodes 12, the step of producing separator-wearing positive electrodes 10, the step of inverting the separator-wearing positive electrodes 10, and the stacking step.

The step of producing positive electrodes 11 and the step of producing negative electrodes 12 include a kneading step, a coating step, a pressing step, an appearance checking step, a decompression and drying step, and a cutting step. The step of producing negative electrodes 12 will be mainly explained hereinafter, the step of producing positive electrodes 11 will be performed in the same manner.

First, in the kneading step, active material particles serving as a main component of the active material layer and particles such as binder and conductive assistant are kneaded in a solvent in a kneader, to produce an electrode mixture with good dispersion of the particles. Thereafter, in the coating step, a rolled band-like metal foil is let out, and the electrode mixture is continuously applied onto the front and the back surfaces of the metal foil. The metal foil coated with the electrode mixture passes through a drying furnace, directly after application of the electrode mixture. In this manner, the solvent included in the electrode mixture is dried and removed, and the binder formed of resin binds the active material particles. In this manner, negative electrode active material layers having fine spaces (pores) between the active material particles are formed on the front and the back surfaces of the band-like metal foil.

Thereafter, in the pressing step, the negative electrode active material layers formed on both the surfaces of the band-like metal foil is pressed with rollers with predetermined pressure. In this manner, the negative electrode active material layers are compressed, and the density of the active material is increased to a proper value. Thereafter, in the appearance checking step, the surface state of the negative electrode active material layers are checked with a camera or the like, to determine whether the product is a non-defective product or a defective product. Thereafter, in the decompression and drying step, the band-like metal foil provided with the negative electrode active material layers is contained in a vacuum drying furnace, to dry the metal foil under reduced pressure and at high temperature. In this manner, the slight solvent remaining in the active material layers is removed.

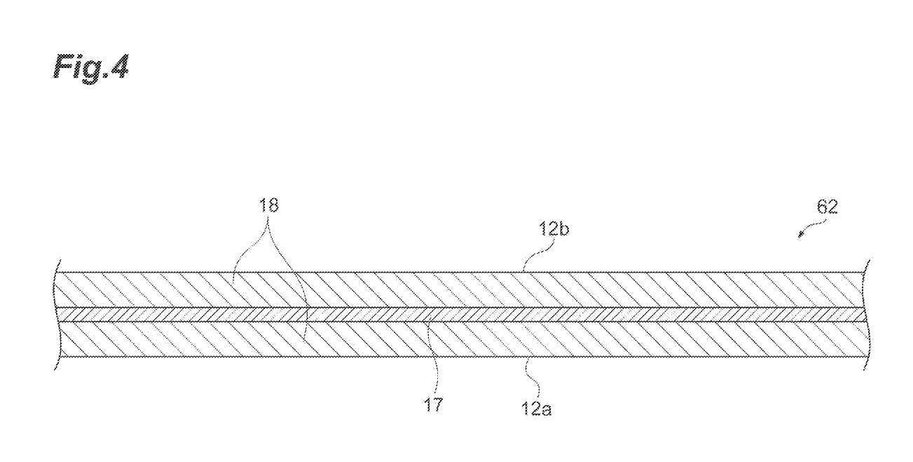

Through the above steps, a band-like negative electrode member 62 is formed, as illustrated in FIG. 4. The band-like negative electrode member 62 has a structure in which the negative electrode active material is applied to the front and the back surfaces of the band-like metal foil 17. Specifically, the kneading step, the coating step, the pressing step, the appearance checking step, and the decompression and drying step described above are included in the negative electrode forming step of continuously applying the negative electrode active material to both the surfaces of the band-like metal foil 17, to form the band-like negative electrode member 62.

In the same manner, also in the step of producing the positive electrodes 11, a band-like positive electrode member 61 in which positive electrode active material is applied to the front and the back surfaces of the band-like metal foil 14 is formed, through the steps described above. Specifically, the kneading step, the coating step, the pressing step, the appearance checking step, and the decompression and drying step described above are included in the positive electrode forming step of continuously applying the positive electrode active material to both the surfaces of the band-like metal foil 14, to form the band-like positive electrode member 61.

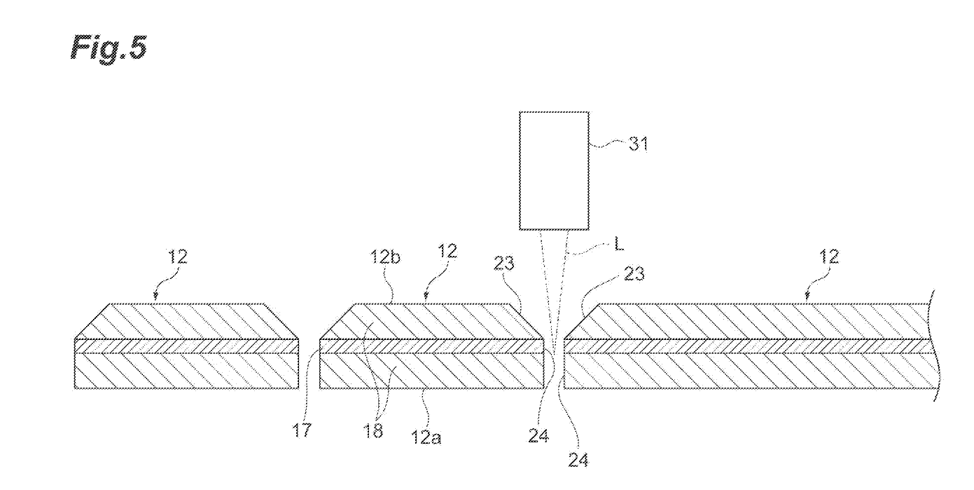

Thereafter, the negative electrode cutting step is executed. In the negative electrode cutting step, negative electrodes 12, each of which has a first main surface 12a and a second main surface 12b, are continuously cut out of the band-like negative electrode member 62. In the negative electrode cutting step, the band-like negative electrode member 62 is carried in a horizontal direction, and the band-like negative electrode member 62 is cut from above with a processing head (processing tool) 31. Specifically, in the negative electrode cutting step, as illustrated in FIG. 5, laser beam L is applied to the band-like negative electrode member 62 from the processing head 31, to cut out a plurality of negative electrodes 12. The processing head 31 is disposed on the upper side of the second main surface 12b. The processing head 31 cuts out negative electrodes 12 of a predetermined shape, with the laser beam L to be applied focused on the metal foil 17. Specifically, the laser beam L is focused on the metal foil 17 serving as portion that is most difficult to cut in the band-like negative electrode member 62. In this manner, the negative electrodes 12 described above are formed.

In the same manner, the positive electrode cutting step is performed. In the positive electrode cutting step, positive electrodes 11, each of which has a first main surface 11a and a second main surface 11b, are continuously cut out of the band-like positive electrode member 61. Also in the positive electrode cutting step, although it is not illustrated, the band-like positive electrode member 61 is carried in a horizontal direction, and the band-like positive electrode member 61 is cut from above with the processing head (processing tool). In this manner, the positive electrodes 11 described above are formed.

Thereafter, in the step of producing separator-wearing positive electrodes 10, each of the positive electrodes 11 is disposed between a pair of sheet-like separators 13a, and the sheet-like separators 13a and 13a forming a pair are welded, to envelop each of the positive electrodes 11 with a pair of sheet-like separators 13a and 13a. In this manner, the separator-wearing positive electrodes 10 are produced.

As an example of the method of disposing the welded portion 13b of each of the bag-like separators 13 on the first main surface 12a side of the positive electrode 11, in welding work, the positive electrode 11 and a pair of sheet-like separators 13a and 13a are arranged, with the first main surface 12a side disposed below, on a jig having a flat upper surface. In this state, a heater of a welder is lowered from above, and welding is performed, with the upper surface of the jig serving as the standard.

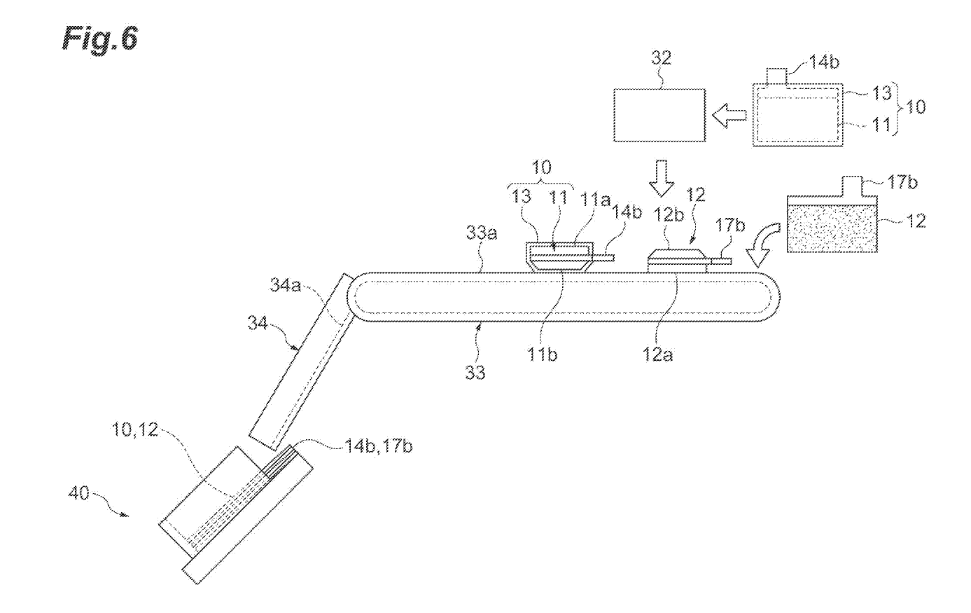

Thereafter, the inverting step is performed. In the inverting step, as illustrated in FIG. 6, each of the separator-wearing positive electrodes 10 is inverted vertically with an inverting device 32. Specifically, in the positive electrode 11 forming the separator-wearing positive electrode 10, the second main surface 11b facing upward is turned to face the bottom, and the first main surface 11a facing downward is turned to face the top.

Thereafter, the separator-wearing positive electrodes 10 and the negative electrodes 12 are alternately placed on the conveying path 33 extending in the horizontal direction. The conveying path 33 is, for example, a belt conveyor. In this state, through the inverting step, each of the separator-wearing positive electrodes 10 is in a state in which the second main surface 11b of the positive electrode 11 faces the conveying surface 33a of the conveying path 33. By contrast, each of the negative electrodes 12 is in the state in which the first main surface 12a of the negative electrode 12 faces the conveying surface 33a of the conveying path 33, because the negative electrode 12 is not subjected to the inverting step.

Thereafter, the stacking step is performed. In the stacking step, the separator-wearing positive electrodes 10 and the negative electrodes 12 are alternately caused to drop into a stacking unit 40 to stack them. In this state, the first main surfaces 11a and 12a of the cut positive electrodes 11 and the negative electrodes 12 are opposed to each other, with the respective bag-like separators 13 interposed therebetween. In addition, the second main surfaces 11b and 12b of the cut positive electrodes 11 and the negative electrodes 12 are opposed to each other, with the respective bag-like separators 13 interposed therebetween.

In the stacking step, a decelerating step is performed before the separator-wearing positive electrodes 10 and the negative electrodes 12 are caused to fall into the stacking unit 40. In the decelerating step, the falling speed of the separator-wearing positive electrodes 10 and the negative electrodes 12 are reduced. The decelerating step is performed by causing the separator-wearing positive electrodes 10 and the negative electrodes 12 to slide on a slider 34 disposed at a downstream end of the conveying path 33. The slider 34 includes an inclined surface 34a inclined downward obliquely with respect to the horizontal direction. The separator-wearing positive electrodes 10 and the negative electrodes 12 slide on the inclined surface 34a, and decelerate by friction caused in the slide against the inclined surface 34a.

As explained above, the electrode assembly 3 has the structure in which the area of the first main surface 11a in each of the positive electrodes 11 is larger than the area of the second main surface 11b, the area of the first main surface 12a in each of the negative electrodes 12 is larger than the area of the second main surface 12b, the area of the first main surface 11a in each of the positive electrodes 11 is smaller than the area of the first main surface 12a of each of the negative electrodes 12, and the area of the second main surface 11b in each of the positive electrodes 11 is smaller than the area of the second main surface 12b of each of the negative electrodes 12. In addition, the first main surfaces 11a and 12a of the positive electrodes 11 and the negative electrodes 12 are opposed to each other, with the respective bag-like separators 13 interposed therebetween, and the second main surfaces 11b and 12b of the positive electrodes 11 and the negative electrodes 12 are opposed to each other, with the respective bag-like separators 13 interposed therebetween. This structure reduces the degree of consideration of the difference in area between the first main surfaces 12a and the second main surfaces 12b of the negative electrodes 12 in design of the positive electrodes 11, and enables increase in sizes of the first main surfaces 11a and the second main surfaces 11b of the positive electrodes 11 to be larger than those of prior art. Accordingly, this structure secures the capacity of the lithium ion secondary battery 1, while lithium deposition is suppressed.

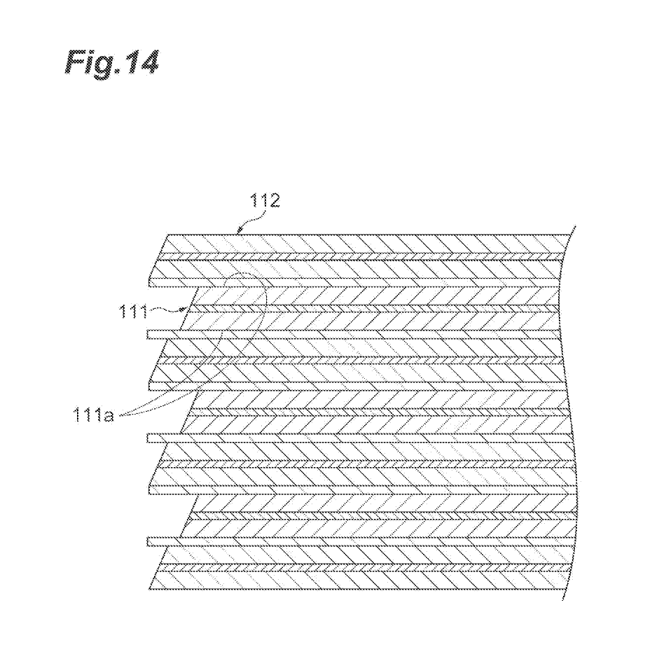

In addition, for example, in the structure illustrated in FIG. 14, the inclination of the end surfaces of the negative electrodes 112 and the inclination of the end surfaces of the positive electrodes 111 continue in the same direction, and the length of the region that does not contact the adjacent electrode increases. For this reason, the end portion is easily broken, when the force acts in the vertical direction of FIG. 14, such as the case of applying a tape in a tensed state to mutually fix the negative electrode 112 and the positive electrode 111. By contrast, in the electrode assembly 3, the length of the region that does not contact the adjacent electrode is leveled and shortened, and the end portion becomes relatively difficult to break.

In addition, each of the positive electrodes 11 is contained in the bag-like separator 13 formed by welding the peripheral portions of two sheet-like separators 13a and 13a, and the welded portion 13b of the bag-like separator 13 is positioned on the first main surface 11a side of the positive electrode 11. This structure superposes the welded portion 13b of the bag-like separator 13 on the lower end of the negative electrode 12 grounded in the case 2, and thus load concentration on the lower end of the negative electrode 12 in grounding can be suppressed.

In addition, the end surfaces 11c and 12c of the positive electrodes 11 and the negative electrodes 12 are provided with the molten portions 25 and 26, respectively, by application of laser beam. The molten portions 25 and 26 include the main molten portions 21 and 23 positioned on the second main surfaces 11b and 12b side, and the subsidiary molten portions 22 and 24 positioned on the first main surfaces 11a and 12a side, and having molten quantities smaller than those of the molten portions 25 and 26, respectively. This structure enables easy cutting of the positive electrodes 11 and the negative electrodes 12, by application of laser beam from the first main surfaces 11a and 12a side.

In the method for producing the electrode assembly 3, in the stacking step, the first main surfaces 11a and 12a of the positive electrodes 11 and the negative electrodes 12 that are cut out are opposed to each other with the respective separators 13 interposed therebetween, and the second main surfaces 11b and 12b of the positive electrodes 11 and the negative electrodes 12 that are cut out are opposed to each other with the respective separators 13 interposed therebetween. This structure reduces the degree of consideration of the difference in area between the first main surface 12a and the second main surface 12b of each of the negative electrodes 12, in design of the positive electrodes 11, and enables setting of the sizes of the first main surface 11a and the second main surface 11b of each of the positive electrodes 11 to be larger than those of conventional art. Accordingly, this structure secures the capacity of the lithium ion secondary battery 1, while lithium deposition is suppressed. Besides, because the positive electrodes 11 are continuously cut out of the band-like positive electrode member 61, and the negative electrodes 12 are continuously cut out of the band-like negative electrode member 62, no end mills are generated, and the material is saved.

Besides, in the positive electrode cutting step and the negative electrode cutting step, the band-like positive electrode member 61 and the band-like negative electrode member 62 are conveyed in the horizontal direction, and the conveyed band-like positive electrode member 61 and band-like negative electrode member 62 are cut from above with the processing head 31. In the stacking step, the cut positive electrodes 11 are vertically inverted, and thereafter the positive electrodes 11 and the negative electrodes 12 are alternately stacked, with the respective bag-like separators 13 interposed therebetween. This structure enables the processing head 31 to be disposed on the upper side of the conveying path, and improves maintainability. In addition, vertically inverting the positive electrodes 11 before stacking causes the first main surfaces 11a and 12a having large areas to be opposed to each other.

### Second Embodiment

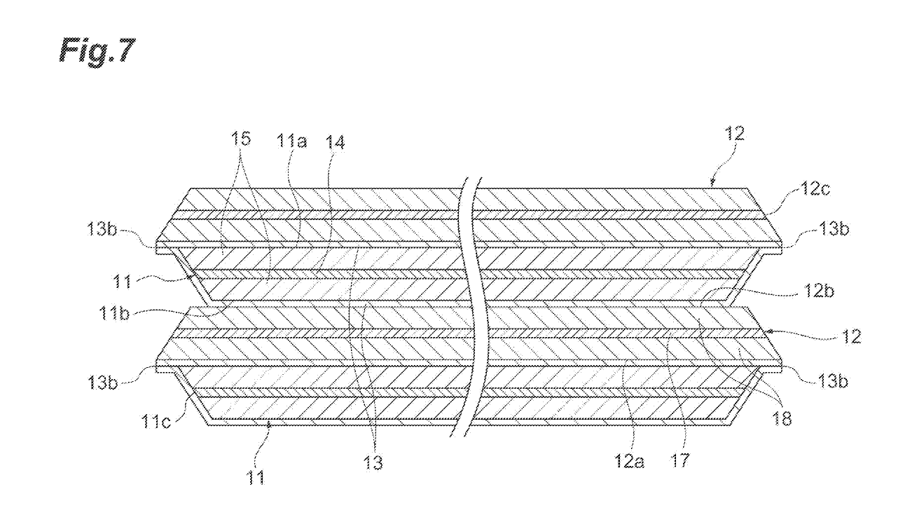

The present embodiment is different from the electrode assembly 3 of the first embodiment, in that the end surface 11c of each of the positive electrodes 11 is a cut surface inclined with respect to the first main surface 11a and the second main surface 11b, and the end surface 12c of each of the negative electrodes 12 is a cut surface inclined with respect to the first main surface 12a and the second main surface 12b, as illustrated in FIG. 7.

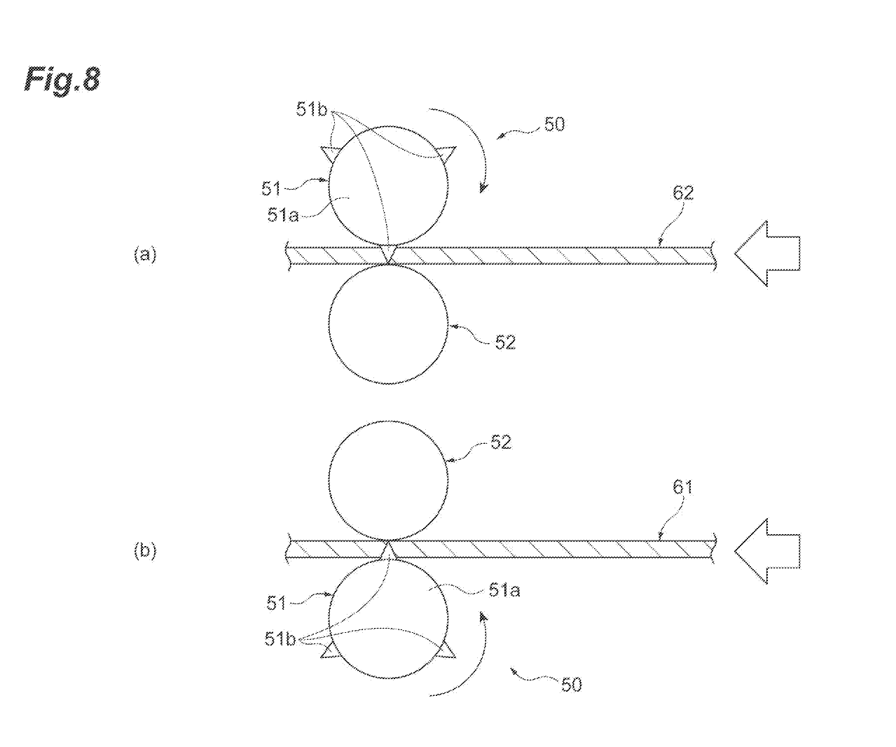

The present embodiment is different from the electrode assembly 3 of the first embodiment, also in that, in the negative electrode cutting step, the band-like negative electrode member 62 is cut with cutting blades 51b to cut out negative electrodes 12, as illustrated in FIG. 8 (a), and, in the positive electrode cutting step, the band-like positive electrode member 61 is cut with cutting blades 51b to cut out positive electrodes 11, as illustrated in FIG. 8 (b).

The cutter (processing tool) 50 is used in each of the cutting steps. For example, a rotary cutting method is adopted in the cutter 50. The cutter 50 includes a cutting roller 51 and a support roller 52 opposed to each other. The cutting roller 51 is formed of a roller main member 51a, and a plurality of cutting blades 51b provided on an external circumferential surface of the roller main member 51a. In each of the cutting steps, each of the band-like positive electrode member 61 and the band-like negative electrode member 62 is cut with the cutting blades 51b, by rotation of the cutting roller 51 at predetermined speed. In this state, the second main surfaces 11b and 12b of the positive electrodes 11 and the negative electrodes 12 are formed on the side on which the cutting roller 51 is disposed. In the same manner, the first main surfaces 11a and 12a of the positive electrodes 11 and the negative electrodes 12 are formed on the side on which the support roller 52 is disposed. Each of the cutting blades 51b is double-edged, and has a V-shaped cross-section symmetrical with respect to the center line of the cutting blade 51b.

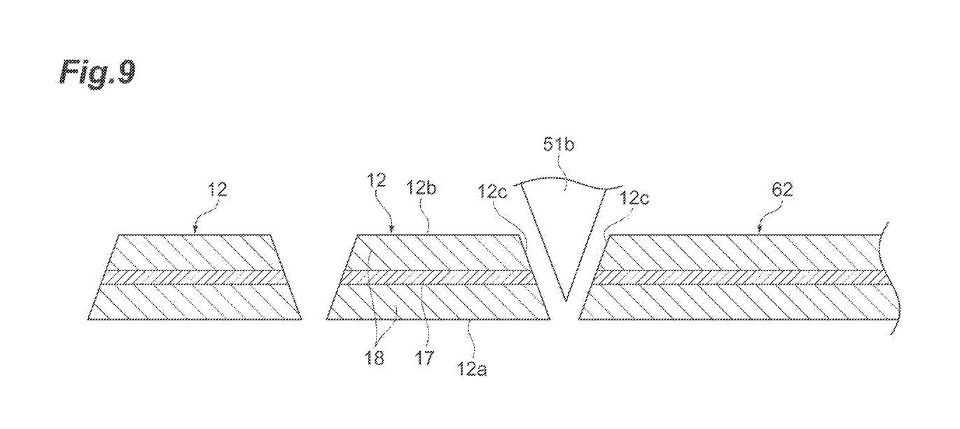

In the negative electrode cutting step, the cutting roller 51 is disposed on the upper side, and the support roller 52 is disposed on the lower side, as illustrated in FIG. 8 (a). Accordingly, as illustrated in FIG. 9, the second main surface 12b having the smaller area in each of the negative electrodes 12 faces upward, and the first main surface 12a having the larger area in each of the negative electrodes 12 faces downward. By contrast, in the positive electrode cutting step, the support roller 52 is disposed on the upper side, and the cutting roller 51 is disposed on the lower side, as illustrated in FIG. 8 (b). Accordingly, although not illustrated, the first main surface 11a having the larger area in each of the positive electrodes 11 faces upward, and the second main surface 11b having the smaller area in each of the positive electrodes 11 faces downward. With the structure, the present embodiment enables turning the second main surfaces 11b of the positive electrodes 11 to the conveying surface 33a of the conveying path 33, without the inverting step.

As explained above, the electrode assembly 3 and the method for producing the same according to the present embodiment also produce the effect described above, that is, the effect of securing the capacity of the lithium ion secondary battery 1, while the lithium deposition is suppressed.

In addition, the end surfaces 11c and the end surfaces 12c of the positive electrodes 11 and the negative electrodes 12 are inclined with respect to the first main surfaces 11a and 12a and the second main surfaces 11b and 12b. This structure enables the positive electrodes 11 and the negative electrodes 12 to be easily cut out with the cutting blades 51b.

The embodiments has been explained above, but an aspect of the present invention is not limited to the first and the second embodiments described above.

Modification 1

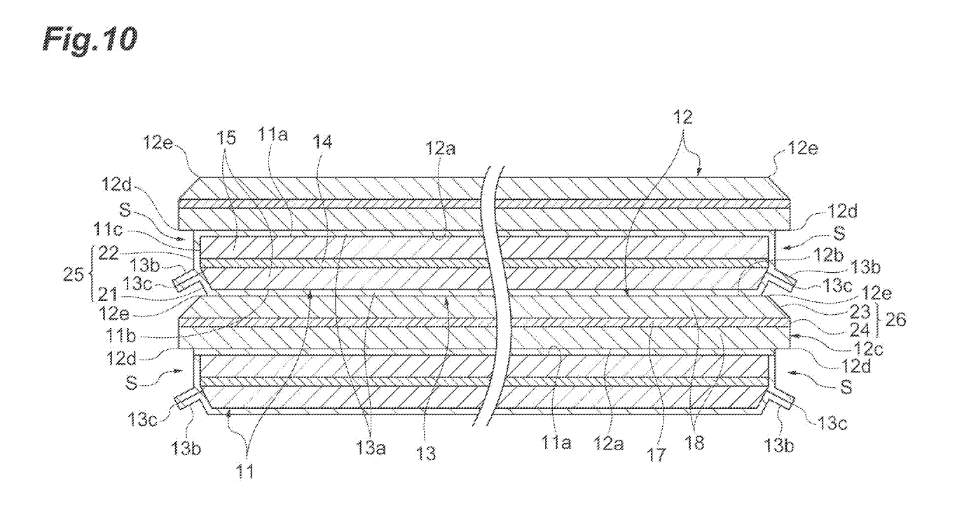

The first embodiment illustrates the example in which the welded portions 13b of the bag-like separators 13 are positioned on the first main surface 11a side of the positive electrodes 11 as illustrated in FIG. 3, but the structure is not limited thereto. For example, as illustrated in FIG. 10, the welded portions 13b of the bag-like separators 13 may extend toward edge portions 13c of the welded portions 13b so as to be away from the first main surfaces 11a of the positive electrodes 11. FIG. 10 illustrates the example in which the end surfaces 11c of the positive electrodes 11 are in close contact with the bag-like separators 13, but slight spaces may be formed between the end surfaces 11c of the positive electrodes 11 and the bag-like separators 13.

An example of forming the welded portions 13b as described above is a method of disposing the positive electrode 11 between sheet-like separators 13a and 13a in a tensed state, and performing welding at an intermediate position between the first main surface 11a and the second main surface 11b of the positive electrode 11. After welding, when the positive electrode 11 is cut along external peripheral edges of the welded portions 13b to release the tension, the welded portions 13b extend in a direction perpendicular to the inclined end surfaces 11c.

In the electrode assembly 3 in which external surfaces of a pair of negative electrode active material layers 18 are formed of the first main surface 12a and the second main surface 12b having an area smaller than that of the first main surface 12a, the negative electrode active material particles more easily fall off the edge portions 12d of the first main surfaces 12a than those on the edge portions 12e of the second main surfaces 12b of the negative electrodes 12 do, and easily form a large aggregate of particles. With the structure of Modification 1, because a relatively large space S is formed between the first main surface 12a of each of the negative electrodes 12 and the welded portion 13b of the bag-like separator 13, the negative electrode active material falling off the edge portion 12d of the first main surface 12a of the negative electrode 12 is easily contained in the space S. Consequently, this structure prevents the fallen negative electrode active material from entering a space between the first main surface 11a of the positive electrode 11 and the first main surface 12a of the negative electrode 12.

Modification 2

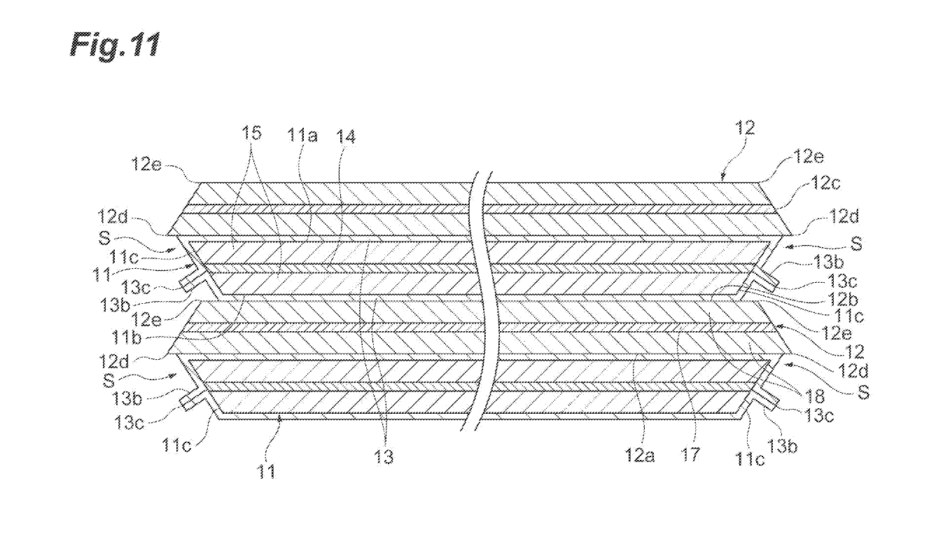

The second embodiment described above illustrates the example in which the welded portions of the bag-like separators 13 are positioned on the first main surface 11a side of the positive electrodes 11 as illustrated in FIG. 7, but the structure is not limited thereto. For example, as illustrated in FIG. 11, the welded portions 13b of the bag-like separators 13 may extend toward the edge portions 13c of the welded portions 13b so as to be away from the first main surfaces 11a of the positive electrodes 11. More specifically, the welded portions 13b of the bag-like separators 13 may extend in a direction substantially perpendicular to the end surfaces 11c of the positive electrodes 11. FIG. 11 illustrates the example in which the end surfaces 11c of the positive electrodes 11 are in close contact with the bag-like separators 13, but slight spaces may be formed between the end surfaces 11c of the positive electrodes 11 and the bag-like separators 13.

In the electrode assembly 3 in which external surfaces of a pair of negative electrode active material layers 18 are formed of the first main surface 12a and the second main surface 12b having an area smaller than that of the first main surface 12a, the negative electrode active material particles more easily fall off the edge portions 12d of the first main surfaces 12a than those on the edge portions 12e of the second main surfaces 12b of the negative electrodes 12 do, and easily form a large aggregate of particles. With the structure of Modification 2, because a relatively large space S is formed between the first main surface 12a of each of the negative electrodes 12 and the welded portion 13b of the bag-like separator 13, the negative electrode active material falling off the edge portion 12d of the first main surface 12a of the negative electrode 12 is easily contained in the space S. Consequently, this structure prevents the fallen negative electrode active material from entering a space between the first main surface 11a of the positive electrode 11 and the first main surface 12a of the negative electrode 12.

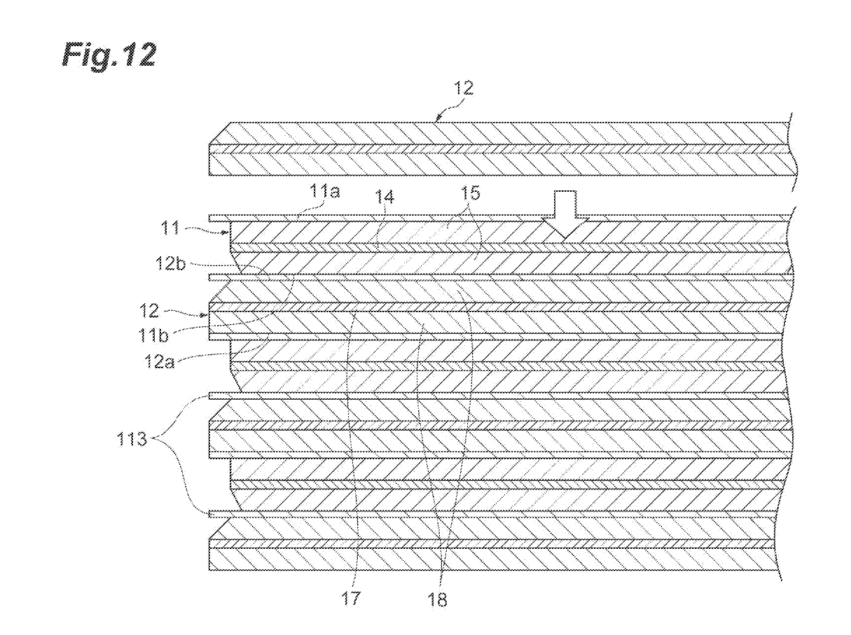

The embodiments or the modifications described above illustrate the structure in which positive electrodes 11 are contained in the respective bag-like separators 13, but the structure is not limited thereto. For example, as illustrated in FIG. 12, the positive electrodes 11 and the negative electrodes 12 may be alternately stacked with sheet-like separators 113 interposed therebetween. In this case, the area of the first main surface 11a having the larger area in each of the positive electrodes 11 may be larger than the area of the second main surface 12b having the smaller area in each of the negative electrodes 12. With the structure, when A is the area of the second main surface 11b of each of the positive electrodes 11, B is the area of the first main surface 11a of each of the positive electrodes 11, C is the area of the second main surface 12b of each of the negative electrodes 12, and D is the area of the first main surface 12a of each of the negative electrodes 12, the following expression (1) is satisfied.

D>B>C>A (1)

Satisfying the relation of the expression (1) described above more secures the capacity of the lithium ion secondary battery 1, while lithium deposition is more suppressed.

The first embodiment illustrates the structure in which the processing head 31 focuses the laser beam L to be applied on the metal foils 14 and 17, but, for example, the processing head 31 may focus the laser beam L on the positive electrode active material layer 15 and the negative electrode active material layer 18.

The first embodiment illustrates the structure in which the processing head 31 is disposed on the upper side of the positive electrodes 11 and the negative electrodes 12 in the cutting steps, but, for example, the processing head 31 may be disposed under the positive electrodes 11 in the positive electrode cutting step. With this structure, the second main surfaces 11b of the positive electrodes 11 are enabled to be turned to the conveying surface 33a of the conveying path 33, without the inverting step.

The second embodiment illustrates the structure in which the cutting blades 51b of the cutter 50 are double-edged, but, for example, the cutting blades 51b may be single-edged (with cross-sections each having a right-triangular shape asymmetrical with respect to the center line of the cutting blade 51b). The second embodiment illustrates the structure in which the cutter 50 adopts a rotary cutting method, but the structure is not limited thereto. For example, the cutter 50 may adopt another method, such as a punching method.

In addition, the embodiments described above illustrate the electrode assembly 3 in which the separator-wearing positive electrodes 10 and the negative electrodes 12 are alternately stacked, but the structure is not limited thereto. For example, the electrode assembly 3 may be a wound-type electrode assembly.

At least parts of the embodiments or the modifications described above may be combined in various forms as desired, within the range not departing from the gist of an aspect of the present invention.

### REFERENCE SIGNS LIST

1 . . . LITHIUM ION SECONDARY BATTERY, 3 . . . ELECTRODE ASSEMBLY, 11 . . . POSITIVE ELECTRODE, 12 . . . NEGATIVE ELECTRODE, 11a, 12a . . . FIRST MAIN SURFACE, 11b, 12b . . . SECOND MAIN SURFACE, 11c, 12c . . . END SURFACE, 13 . . . BAG-LIKE SEPARATOR (SEPARATOR), 13a . . . SHEET-LIKE SEPARATOR, 14 . . . METAL FOIL (POSITIVE ELECTRODE COLLECTOR), 15 . . . POSITIVE ELECTRODE ACTIVE MATERIAL LAYER (POSITIVE ELECTRODE ACTIVE MATERIAL), 17 . . . METAL FOIL (NEGATIVE ELECTRODE COLLECTOR), 18 . . . NEGATIVE ELECTRODE ACTIVE MATERIAL LAYER (NEGATIVE ELECTRODE ACTIVE MATERIAL), 25, 26 . . . MOLTEN PORTION, 21, 23 . . . MAIN MOLTEN PORTION, 22, 24 . . . SUBSIDIARY MOLTEN PORTION, 61 . . . BAND-LIKE POSITIVE ELECTRODE MEMBER, 62 . . . BAND-LIKE NEGATIVE ELECTRODE MEMBER, 31 . . . PROCESSING HEAD (PROCESSING TOOL), 50 . . . CUTTER (PROCESSING TOOL), 113 . . . SEPARATOR.

1. An electrode assembly of a lithium ion secondary battery in which sheet-like positive electrodes and sheet-like negative electrodes are alternately stacked, with separators interposed therebetween, wherein
the positive electrodes each include an positive electrode collector and a pair of positive electrode active material layers formed on front and back surfaces of the positive electrode collector,
the negative electrodes each include a negative electrode collector and a pair of negative electrode active material layers formed on front and back surfaces of the negative electrode collector,
external surfaces of the positive electrode active material layers form a first main surface of the positive electrode and a second main surface of the positive electrode with an area smaller than an area of the first main surface,
external surfaces of the negative electrode active material layers form a first main surface of the negative electrode and a second main surface of the negative electrode with an area smaller than an area of the first main surface,
the area of the first main surface of each of the positive electrodes is smaller than the area of the first main surface of each of the negative electrodes,
the area of the second main surface of each of the positive electrodes is smaller than the area of the second main surface of each of the negative electrodes,
the first main surfaces of the positive electrodes and the negative electrodes are opposed to each other, with the respective separators interposed therebetween, and
the second main surfaces of the positive electrodes and the negative electrodes are opposed to each other, with the respective separators interposed therebetween.

2. The electrode assembly of a lithium ion secondary battery according to claim 1, wherein
the positive electrodes are contained in respective bag-like separators, each of which being formed by welding peripheral edge portions of two sheet-like separators, and
the welded portions of the bag-like separators are positioned on the first main surface side of the positive electrodes.

3. The electrode assembly of a lithium ion secondary battery according to claim 1, wherein
the positive electrodes are contained in respective bag-like separators, each of which being formed by welding peripheral edge portions of two sheet-like separators, and
the welded portions of the bag-like separators extend toward edge portions of the welded portions so as to be away from the first main surfaces of the positive electrodes.

4. The electrode assembly of a lithium ion secondary battery according to claim 1, wherein
molten portions are formed on the respective end surfaces of each of the positive electrodes and the negative electrodes, and
each of the molten portions includes a main molten portion positioned on the second main surface side, and a subsidiary molten portion positioned on the first main surface side and having a molten quantity smaller than a molten quantity of the main molten portion.

5. The electrode assembly of a lithium ion secondary battery according to claim 1, wherein end surfaces of the positive electrodes and the negative electrodes are inclined with respect to the first main surfaces and the second main surfaces.

6. A method for producing an electrode assembly of a lithium ion secondary battery, comprising:
an positive electrode forming step of continuously applying positive electrode active material to front and back surfaces of a band-like positive electrode collector to form a band-like positive electrode member;
a negative electrode forming step of continuously applying negative electrode active material to front and back surfaces of a band-like negative electrode collector to form a band-like negative electrode member;
an positive electrode cutting step of continuously cutting positive electrodes, each having a first main surface and a second main surface having an area smaller than an area of the first main surface, out of the band-like positive electrode member;
a negative electrode cutting step of continuously cutting negative electrodes, each having a first main surface and a second main surface having an area smaller than an area of the first main surface, out of the band-like negative electrode member; and
a stacking step of alternately stacking the positive electrodes and the negative electrodes, with respective separators interposed therebetween such that the first main surfaces of the cut positive electrodes and the cut negative electrodes are opposed to each other, with the respective separators interposed therebetween, and the second main surfaces of the cut positive electrodes and the cut negative electrodes are opposed to each other, with the respective separators interposed therebetween.

7. The method for producing an electrode assembly of a lithium ion secondary battery according to claim 6, wherein
in the positive electrode cutting step and the negative electrode cutting step, the band-like positive electrode member and the band-like negative electrode member are conveyed in the horizontal direction, and the conveyed band-like positive electrode member and the conveyed band-like negative electrode member are cut from above with a processing tool, and
in the stacking step, either the cut positive electrodes or the cut negative electrodes are inverted vertically, and thereafter the positive electrodes and the negative electrodes are alternately stacked, with the separators interposed therebetween.
